(19) United States
(12) Patent Application Publication
(10) Pub. No.: US 2012/0133982 A1
(43) Pub. Date: May 31, 2012

(54) PRINTING SYSTEM AND INFORMATION PROCESSING APPARATUS

(75) Inventors: Shohei NAGAI, Nagoya-shi (JP); Toyoshi INOUE, Nagoya-shi (JP)

(73) Assignee: BROTHER KOGYO KABUSHIKI KAISHA, Aichi-ken (JP)

(21) Appl. No.: 13/303,778

(22) Filed: Nov. 23, 2011

(30) Foreign Application Priority Data
Nov. 29, 2010 (JP) 2010-265739

(51) Int. Cl. G06F 3/12

(52) U.S. Cl. 358/1.15

(57) ABSTRACT

A printing system includes: a plurality of printers; an information processing apparatus including a designation unit configured to receive, from user's input, search condition for searching the printers in which the print jobs are to be registered, a search unit configured to search for the printers satisfying the search condition received by the designation unit, a determination unit configured to determine the printers from the printers searched by the search unit, and a registering unit configured to register print jobs based on a same print target in the printers determined by the determination unit. The printer in which the print job is registered starts printing in response to a print instruction.

### CROSS REFERENCE TO RELATED APPLICATION

This application is based upon and claims the benefit of priority of Japanese Patent Application No. 2010-265739 filed on Nov. 29, 2011, the contents of which are incorporated herein by reference in its entirety.

### BACKGROUND

The present disclosure relates to a printing system and an information processing apparatus. More particularly, the present disclosure relates to a printing system and an information processing apparatus that registers print jobs in printers and start printing in response to printing instructions of the print jobs.

According to the related art, there has been a printing system including a plurality of printers, in which some printers are selected from the printer group, a print job is registered in the selected printers, and if a printing instruction of the print job is given to a printer which is a registration destination, the corresponding printer executes printing. For example, such a system is known that the same secure job is registered in a plurality of printers, that any one printer starts printing of a secure job after performing authentication, etc.

### SUMMARY

However, the printing system according to the related art has the following problem. That is, when the print job is registered, it is required to select printers to be registration destinations of the print job from the plurality of printers. This printer selecting work needs efforts for a user and has room for improvement.

An aspect of the present disclosure was made in order to solve the problem of the printing system according to the related art. That is, an object is to provide a printing system and an information processing apparatus which need a little effort for the user when a registration destination of a print job is selected.

A printing system according to the aspect of the disclosure includes:

a plurality of printers; and

an information processing apparatus including:
a designation unit configured to receive, from user's input, search condition for searching the printers in which print jobs are to be registered;
a search unit configured to search for the printers satisfying the search condition received by the designation unit;
a determination unit configured to determine the printers from the printers searched by the search unit; and
a registering unit configured to register print jobs based on a same print target in the printers determined by the determination unit,

wherein the printer in which the print job is registered starts printing in response to a print instruction.

An information processing apparatus according to the aspect of the disclosure for controlling a plurality of printers, includes:

a designation unit configured to receive, from user's input, search condition for searching the printers in which the print jobs are to be registered; and

a search unit configured to search for the printers satisfying the search condition received by the designation unit; and

a determination unit configured to determine the printers from the printers searched by the search unit; and

a registering unit configured to register print jobs based on a same print target in the printers determined by the determination unit.

### BRIEF DESCRIPTION OF DRAWINGS

FIG. 1 is a block diagram illustrating a configuration of a printing system according to an embodiment.

FIG. 2 is a block diagram illustrating an electrical configuration of a PC and a printer included in the printing system.

FIG. 3 is a block diagram illustrating an outline of secure printing.

FIG. 4 is a block diagram illustrating screen transitions of a manipulation screen during a transmission-destination-printer selection.

FIG. 5 is a diagram illustrating a main screen during the transmission-destination-printer selection.

FIG. 6 is a diagram illustrating a search area registration screen during the transmission-destination-printer selection.

FIG. 7 is a diagram illustrating a search area selection screen during the transmission-destination-printer selection.

FIG. 8 is a diagram illustrating a transmission-destination selection screen during the transmission-destination-printer selection.

FIG. 9 is a flow chart illustrating a procedure of a search area registration process of the PC.

FIG. 10 is a flow chart illustrating a procedure of a printer search process of the PC.

FIG. 11 is a flow chart illustrating a procedure of a transmission-destination selection process of the PC.

FIG. 12 is a flow chart illustrating a procedure of a job transmission process of the PC.

### DESCRIPTION OF EXEMPLARY EMBODIMENTS

Hereinafter, a printing system according to an exemplary embodiment will be described in detail with reference to the accompanying drawings. The printing system according to the present embodiment includes a plurality of printers and a personal computer (PC) for registering secure jobs in the plurality of printers.

### Entire Configuration of Printing System

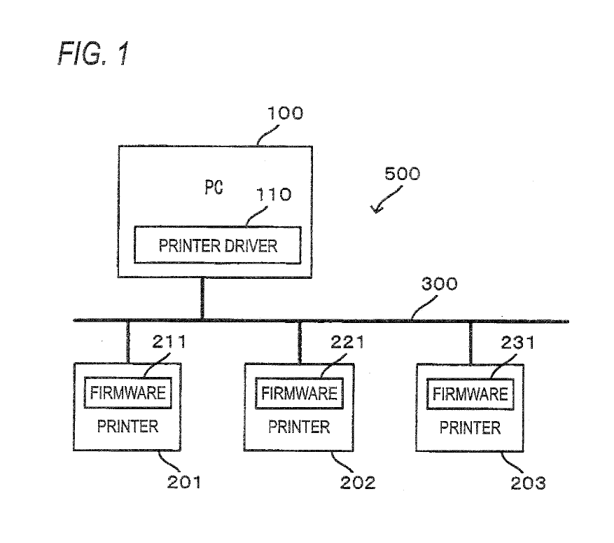

A printing system 500 according to the exemplary embodiment includes printers 201, 202, and 203 having a secure print function and a PC 100 for outputting print data to the printers, as shown in FIG. 1. The printers 201, 202, and 203 need not necessarily be the same model (type), and may be different from one another. In the printing system 500, the PC 100 and the printers 201, 202, and 203 are connected to one another through a network 300 such as Ethernet (a registered trademark).

The PC 100 includes a printer driver 110 for outputting print jobs corresponding to the printers 201, 202, and 203. The printer driver 110 of the present embodiment is a universal driver capable of dealing with a plurality of printer types, and generates print jobs according to the specifications of the printers 201, 202, and 203. The printer driver 110 of the PC 100 is not limited to a universal printer driver, but may be configured by incorporating printer drivers corresponding to the printers.

The printer 201 includes firmware 211 for controlling an image forming unit, a manipulation unit, and the like. The other printers 202 and 203 also include firmware 221 and firmware 231 according to their types, respectively.

In the present embodiment, the printing system 500 includes one PC and three printers. However, the present invention is not limited thereto. The printing system 500 may include one or more PCs and one or more printers. Also, the printing system 500 may be connected to other information processing apparatuses or image processing apparatuses.

### Configuration of PC

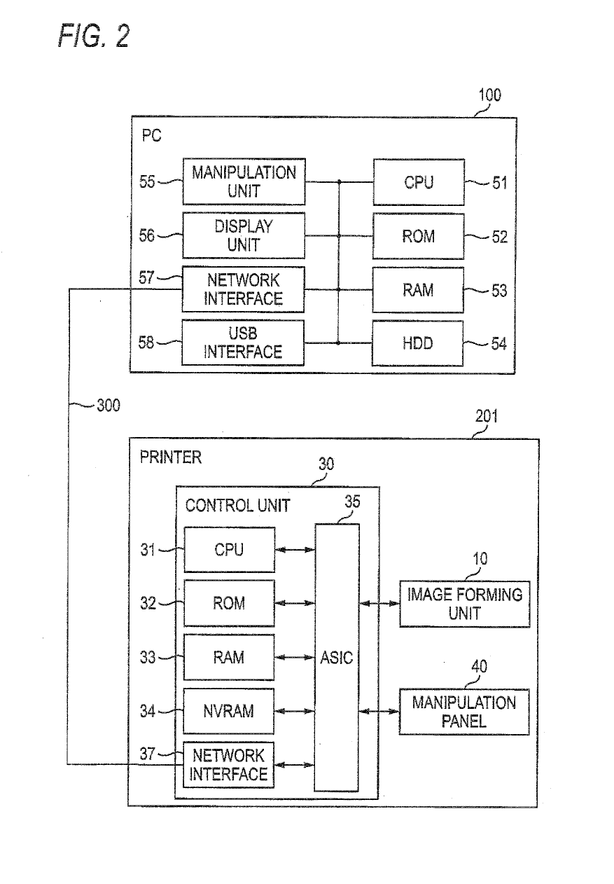

Subsequently, a schematic configuration of the PC 100 will be described. The PC 100 includes a CPU 51, a ROM 52, a RAM 53, a HDD 54, a manipulation unit 55 such as a keyboard and a mouse, a display unit 56 composed of a liquid crystal display or the like, a network interface 57, and a USB interface 58, as shown in FIG. 2.

The HDD 54 (an example of a search-result storage unit and a search condition storage unit) of the PC 100 stores an operating system (OS), device drivers for controlling various kinds of devices, application programs, such as a word processor and a spreadsheet program, having printing instruction functions, and the like. The printer driver 110 also is stored in the HDD 54.

The CPU 51 (an example of a designation unit, a search unit, a determination unit, a transmission unit, a prohibition unit, a selection unit, and a setting unit) executes various kinds of processes while storing computation results in the RAM 53 or the HDD 54 in accordance with control programs read from the ROM 52, application programs read from the HDD 54, and the like. The operation of the printer driver 110 also is processed by the CPU 51.

The network interface 57 and the USB interface 58 are interfaces enabling communication with external devices. In the present embodiment, the PC 100 performs data communication with the printer 201 and others through the network interface 57.

### Configuration of Printer

Subsequently, a schematic configuration of the printer 201 will be described. The printer 201 includes a control unit 30 which includes a CPU 31, a ROM 32, RAM 33, anon-volatile RAM (NVRAM) 34, an ASIC 35, and a network interface 37, as shown in FIG. 2. The control unit 30 is electrically connected to an image forming unit 10 for forming images on sheets, and a manipulation panel 40 for displaying operation states and receiving input manipulation of a user. The printers 202 and 203 have almost the same configuration as that of the printer 201, and thus the redundant description will not be repeated.

The ROM 32 stores the firmware 211 which is a control program for controlling the printer 201, various kinds of set options, initial values, etc. The RAM 33 is used as a work area to which various kinds of control programs are read, or a storage area which temporarily stores image data.

The CPU 31 controls the individual components of the printer 201 through the ASIC 35 while storing process results in the RAM 33 or the NVRAM 34 in accordance with control programs read from the ROM 32 and signals transmitted from various kinds of sensors. The operation of the firmware 211 also is processed by the CPU 31.

The network interface 37 is an interface enabling communication with external devices. In the present embodiment, the printer 201 performs data communication with the PC 100 and others through the network interface 37.

### Outline of Secure Printing

Subsequently, secure printing of the printing system 500 will be described. In the printing system 500 of the present embodiment, secure jobs which are print jobs having a set password are transmitted to a plurality of printers. If receiving the secure job, the printers register the secure job in their memories and enter a printing standby state. Then, if password authentication is executed in one of the printers, printing regarding the secure job is executed. Hereinafter, printing using such secure jobs is referred to as secure printing.

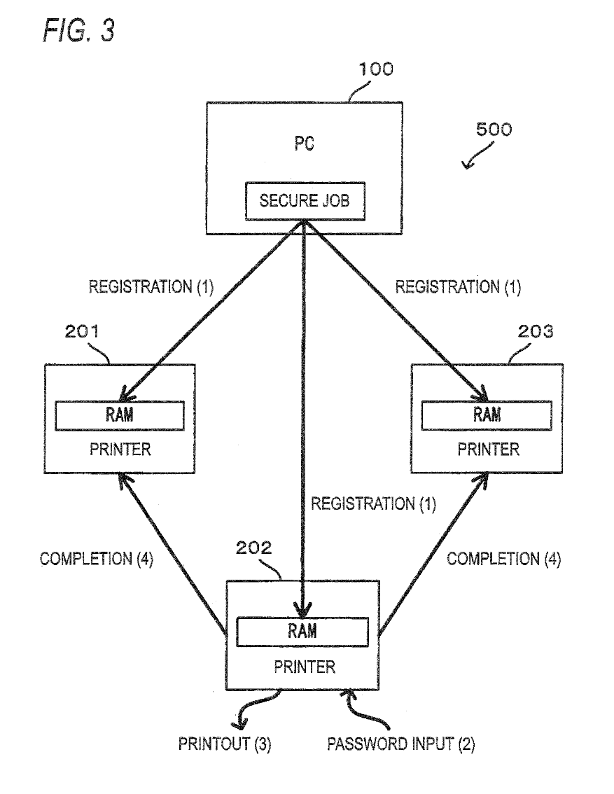

Specifically, in the printing system 500, as shown in FIG. 3, the PC 100 generates secure jobs, and if the user selects registration destination printers of the secure jobs, the PC 100 transmits the secure jobs to the selected printers (the printers 201, 202, and 203 in FIG. 3). If receiving the secure jobs, the printers register the secure jobs in their NVRAM 34 or RAM 33 (registration (1)).

Then, the user inputs the password to one of the printers 201, 202, and 203 having received the secure jobs (the printer 202 in FIG. 3) through the manipulation panel 40 (password input (2)). The printer to which the password has been input compares the input password with the password set for the secure job, and starts printing of the secure job having that password (printout (3)) if both passwords correspond to each other. After completing the printing, the printer outputs a completion notification to the other printers. If receiving the completion notification, the other printers eliminate the same job as the secure job of which printing has been completed (completion (4)).

The secure printing does not start until the user inputs an appropriate password. Therefore, other people cannot see the printout or take the printout away, and thus confidentiality is high. Moreover, printing of confidential documents can be supposed on the basis of the high confidentiality, and thus demand for the reliability of printing also is high.

### Transmission-Destination-Printer Selection

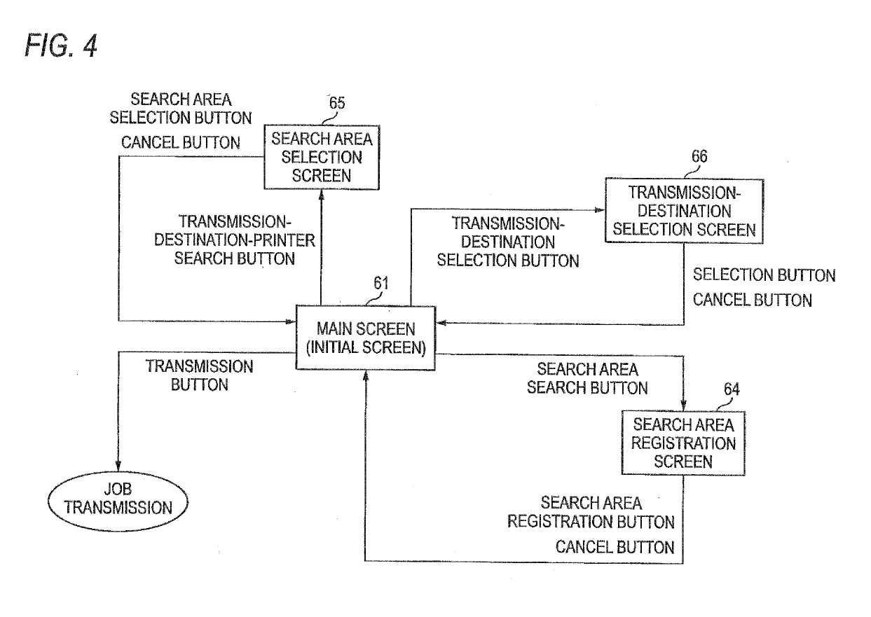

Subsequently, a procedure in which printers to be transmission destinations (transmission destination printers) for secure-job transmission are selected will be described in accordance with user's manipulations. FIG. 4 shows screen transitions of a manipulation screen displayed on the display unit 56 of the PC 100 by the printer driver 110 when the transmission destination printers are determined, that is, when transmission of the secure jobs has been instructed.

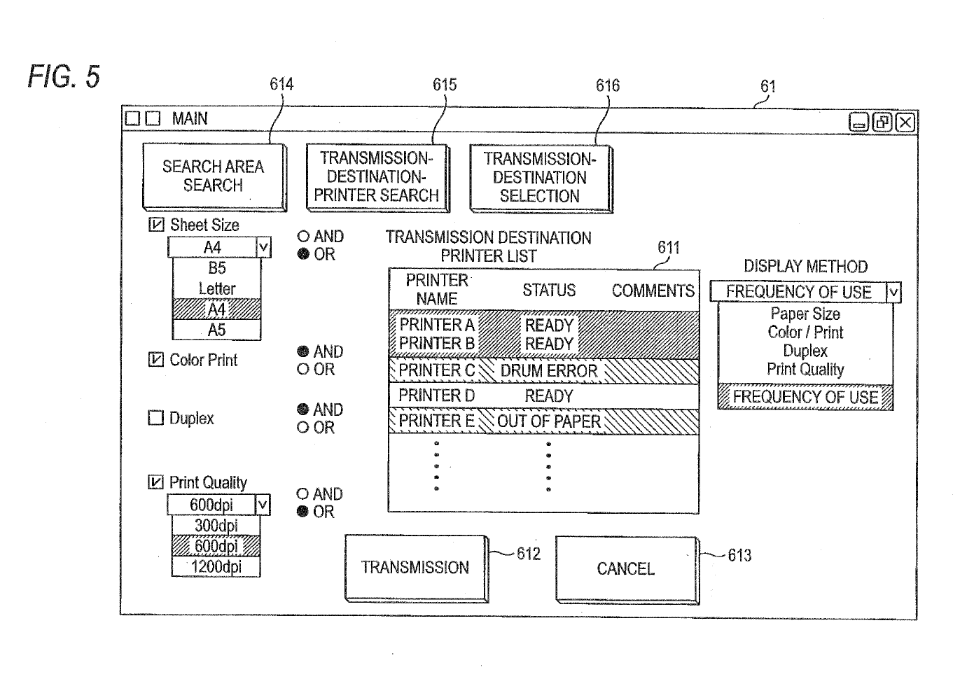

After the user instructs the PC 100 to transmit the secure jobs, the PC 100 displays a main screen 61 as shown in FIG. 5, as an initial screen. The manipulation screen can transition from the main screen 61 to various kinds of screens such as a search area registration screen 64, a search area selection screen 65, and a transmission-designation selection screen 66.

The main screen 61 (an example of the designation unit and the selection unit) displays search parameters, such as ‘Sheet Size’, ‘Color Print’, ‘Duplex Print’, and ‘Image Quality’, with check boxes, so as to enable the user to select whether to set each of the search parameters by the check boxes. The initial states of the search parameters depend on the set state of the secure jobs. For example, if color printing on A4 size has been designated in the secure jobs, at least ‘Sheet Size’ (set to the A4 size) and ‘Color Print’ are selected.

Each of the search parameters of the main screen 61 can be set to be used conjunctively with or disjunctively from the other search parameters by radio buttons ‘AND’ and ‘OR’, and thus the search parameters can be freely combined. For example, in FIG. 5, ‘Sheet Size’ (set to the A4 size), ‘Color Print’, and ‘Image Quality’ (set to 600 dpi) has been selected as search parameters, the parameter ‘Color Print’ has been set to be used conjunctively with the other parameters, and the other search parameters have been to be disjunctively from the parameter ‘Color Print’. Therefore, the search condition becomes {‘Color Print’ AND (‘A4 Size’ OR ‘600 dpi’)}, that is, ° Printer capable of color printing on A4 sheet size or capable of color printing at 600 dpi'. Initially, all search parameters are set to be used conjunctively with one another.

The main screen 61 further includes a list box 611 displaying a list of printer search results. The list box 611 does not display anything initially, and displays printer search results if a transmission-destination-printer search button 615 or a transmission-destination selection button 616 is pushed. A printer search procedure will be described below. After printer search results are acquired and a list of the printer search results is displayed, the search parameters may be reset, and then re-searching may be executed, so as to reflect the results of the re-searching to the list box 611.

Items displayed in the list box 611 of the main screen 61 include, for example, ‘Printer Name’ and ‘Status of Printer’, and thus it is possible to grasp which printers are available, at a glance. Also, the list box 611 can display a plurality of printers, and display priorities can be determined as a display method. Sort items for determining the priorities may include the search parameters such as ‘Sheet Size’, ‘Color Print’, ‘Duplex Print’, and ‘Image Quality’, and ‘Frequency of Use of Printer’. The frequency of use of each printer is determined by the number of times of printing, and the date and time when the corresponding printer was used most lately. Only one sort item can be selected, and the printers displayed in the list box 611 can be sorted by the selected item.

Printers in the list box 611 of the main screen 61 can be individually selected. That is, in the list box 611, a plurality of printers can be selected. In the present embodiment, immediately after printer search, all of printers capable of printing are displayed in a selected state in the list box 611. Further, printers incapable of printing (for example, an out-of-order printer and an out-of-paper printer) are displayed in an unselectable state. The user can deselect each of the printers displayed in the list box 611 by manipulation. For example, in FIG. 5, in the list box 611, items ‘Printer A’ and ‘Printer B’ are in the selected state. In this state, if the user clicks the item ‘Printer A’, the item ‘Printer A’ becomes an unselected state. Although deselected printers are printers displayed in the list box 611, that is, printers satisfying the search condition, the deselected printers are eliminated from transmission destinations of the secure jobs.

In a lower portion of the main screen 61, a transmission button 612 and a cancel button 613 are displayed. If the transmission button 612 is pushed, the secure jobs are transmitted to all of printers which are in the selected state in the list box 611 at the time when the transmission button 612 is pushed. After the secure-job transmission, the main screen 61 is closed. Meanwhile, if the cancel button 613 is pushed, all of the set search condition and the search results are canceled and the main screen 61 is closed.

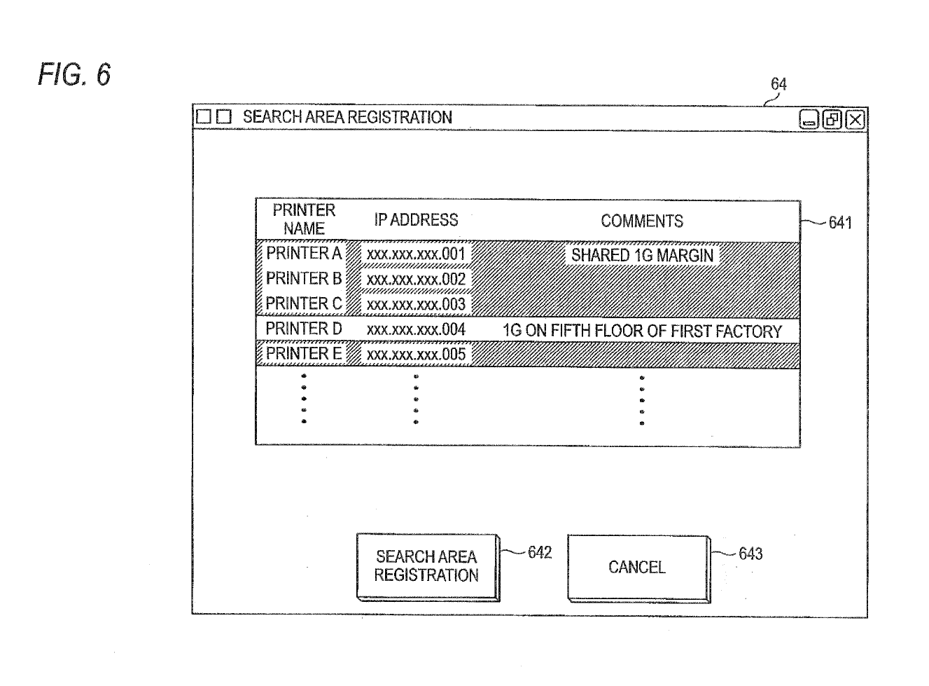

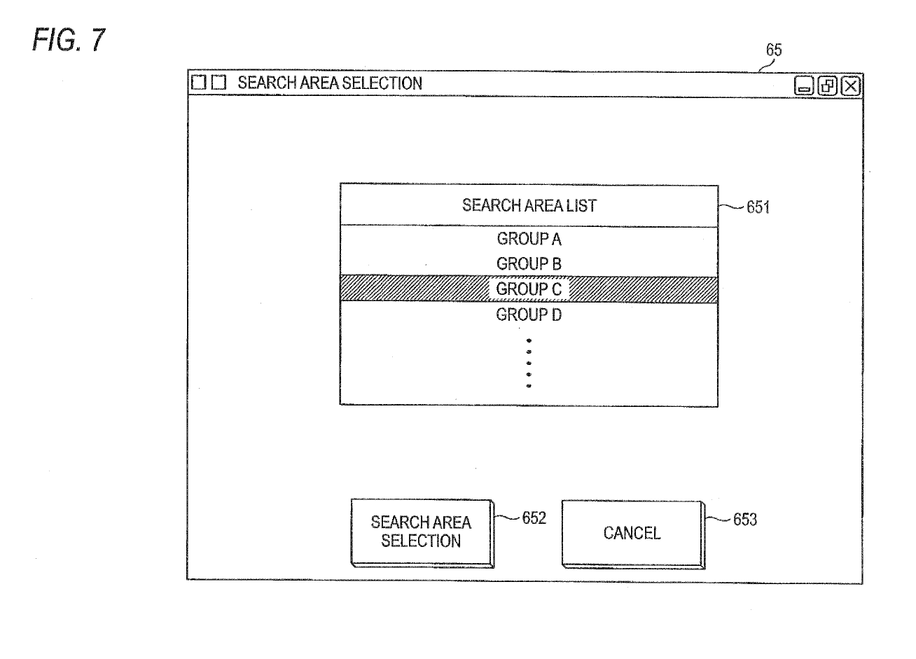

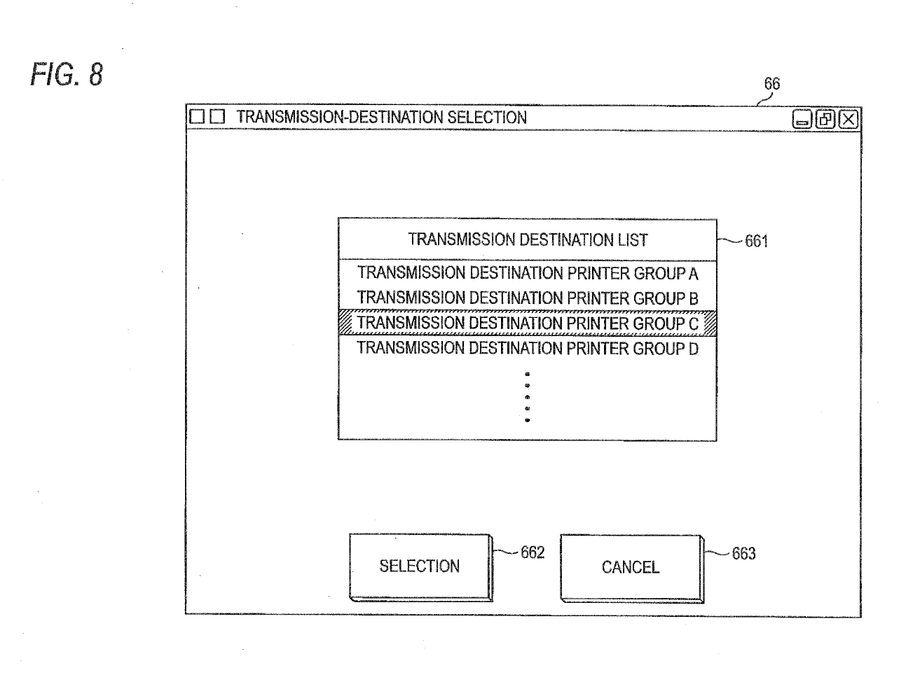

In an upper portion of the main screen 61, a search area search button 614, the transmission-destination-printer search button 615, and the transmission-destination selection button 616 are displayed. If the search area search button 614 is pushed, a search area registration screen 64 as shown in FIG. 6 is displayed. If the transmission-destination-printer search button 615 is pushed, a search area selection screen 65 as shown in FIG. 7 is displayed. If the transmission-destination selection button 616 is pushed, the transmission-destination selection screen 66 as shown in FIG. 8 is displayed.

The search area registration screen 64 (an example of the setting unit) is a screen for determining a search area for printer search. The search area registration screen 64 displays a list of all of printers communicable with the PC 100 in a list box 641. Items displayed in the list box 641 include, for example, ‘Printer Name’, ‘IP Address’, and ‘Comments (representing information on installation positions and the like)’. Printers displayed in the list box 641 can be individually selected by user's manipulation, and selected printers are highlighted. In the list box 641, since the printers can be individually selected, a plurality of printers can be selected.

In a lower portion of the search area registration screen 64, a search area registration button 642 and a cancel button 643 are displayed. If the search area registration button 642 is pushed, a printer set composed of all of printers selected in the list box 641 is registered as one group in the PC 100. After the group (search area) is registered, the search area registration screen 64 is closed. In a case where the search area registration button 642 is pushed in a state in which there is no selected printer, an error message is displayed to urge printer selection. Meanwhile, if the cancel button 643 is pushed, all of the selected printers in the list box 641 are canceled, and the search area registration screen 64 is closed.

The search area selection screen 65 is a screen for determining a printer search area to be a search subject on an occasion of printer search. The search area selection screen 65 displays a list of search areas registered in the PC 100, in a list box 651. Only one of the search areas displayed in the list box 651 can be selected by user's manipulation, and a selected search area is highlighted.

In a lower portion of the search area selection screen 65, a search area selection button 652 and a cancel button 653 are displayed. If the search area selection button 652 is pushed, a group selected in the list box 651 is set as a search area, and search is executed on the basis of the search condition set in the main screen 61. Specifically, inquiring of all the printers constituting the search area about specifications is executed, and printers satisfying the search condition are extracted on the basis of the results of the inquiring. With this printer search, the search area selection screen 65 is closed. A list of searched printers is displayed in the list box 611 of the main screen 61. After the printer search, the search results are registered as one transmission destination printer group in the PC 100. Meanwhile, if the cancel button 653, the selection of the search area in the list box 651 is canceled and the search area selection screen 65 is closed.

The transmission-destination selection screen 66 is a screen for reading a search result (transmission destination group) registered in the PC 100. The transmission-destination selection screen 66 displays a list of the search results registered in the PC 100, in a list box 661. Only one of the search results displayed in the list box 661 can be selected by user's manipulation, and a selected search result is highlighted.

In a lower portion of the transmission-destination selection screen 66, a selection button 662 and a cancel button 663 are displayed. If the selection button 662 is pushed, registration contents of the transmission destination group selected in the list box 661 are read. After the transmission destination group is read, the transmission-destination selection screen 66 is closed. Then, a list of printers constituting the read transmission destination group is displayed in the list box 611 of the main screen 61. Meanwhile, if the cancel button 663 is pushed, selection of a search result in the list box 661 is canceled, and the transmission-destination selection screen 66 is closed.

### Secure-Job Registration Procedure

Subsequently, a secure-job registration procedure, that is, specific procedures of the transmission-destination selection and the transmission of the secure jobs to selected printers will be described.

### Search Area Registration Process

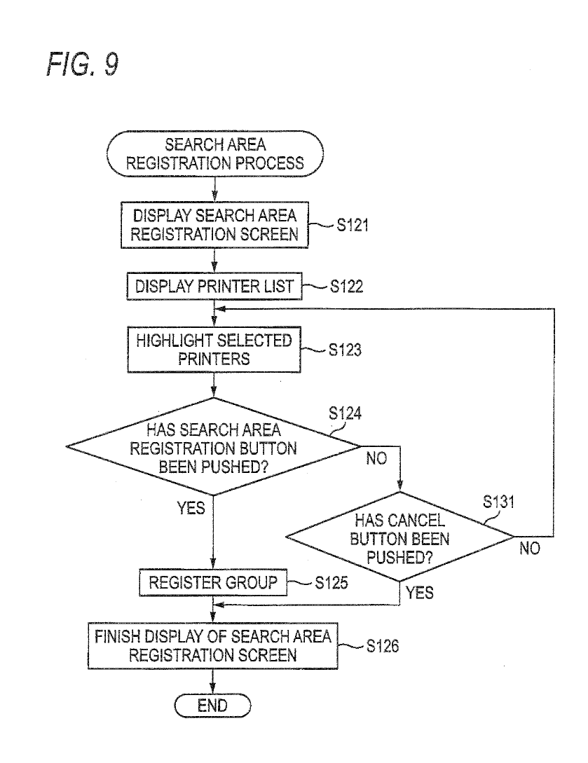

First, a search area registration process will be described with reference to a flow chart of FIG. 9. The search area registration process is executed by the CPU 51 if the search area search button 614 of the main screen 61 is pushed.

In the search area registration process, first, in step S121, the search area registration screen 64 (see FIG. 6) is displayed. Next, in step S122, a list of printers communicable with the PC 100 is displayed in the list box 641. For example, a list of printers on a sub network identified by a subnet mask is displayed. Immediately after the list display, in an initial state, all printers in the list box 641 are in an unselected state. Then, in step S123, if user selects printers by manipulation, the selected printers are highlighted. Therefore, the selected printers are distinguished from unselected printers.

Next, in step S124, it is determined whether the search area registration button 642 has been pushed. If it is determined that the search area registration button 642 has not been pushed (No in step S124), in step S131, it is determined whether the cancel button 643 has been pushed. If it is determined that the cancel button 643 has not been pushed (No in step S131), the search area registration process returns to step S123, and a standby state maintains until the user pushes the search area registration button 642 or the cancel button 643.

If it is determined that the search area registration button 642 has been pushed (Yes in step S124), in step S125, a set of the printers selected in the list box 641 is registered as a group in the PC 100. The name of the group may be set by the user or may be automatically assigned by the PC 100, during registration. After the search area group is registered, in step S126, the display of the search area registration screen 64 finishes, thereby ending the search area registration process.

Meanwhile, if it is determined that the cancel button 643 has been pushed (Yes in step S131), in step S126, the display of the search area registration screen 64 finishes without registering the search area group, thereby ending the search area registration process.

### Printer Search Process

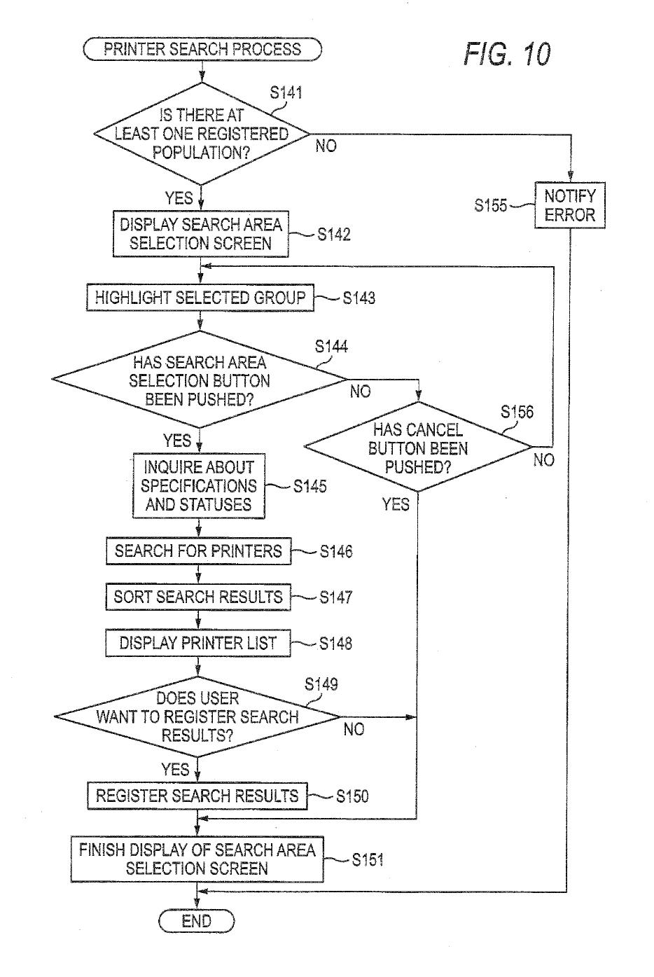

Subsequently, a printer search process (an example of the search unit and the determination unit) will be described with reference to a flow chart of FIG. 10. The printer search process is executed by the CPU 51 if the search area search button 615 of the main screen 61 is pushed.

In the printer search process, first, in step S141, it is determined whether there is at least one search area registered in the PC 100. If it is determined that there is no registered search area (No in step S141), in step S155, an error message representing that there is no registered search area is notified, and the printer search process ends.

Meanwhile, if it is determined that there is at least one registered search area (Yes in step S141), in step S142, the search area selection screen 65 (see FIG. 7) is displayed. At this time, a list of registered search areas (groups) is displayed in the list box 651. After the list display, in an initial state, a group displayed on the top of the list box 651 is in a selected state. Next, in step S143, if the user selects a group by manipulation, the selected group is highlighted.

Next, in step S144, it is determined whether the search area selection button 652 has been pushed. If it is determined that the search area selection button 652 has not been pushed (No in step S144), in step S156, it is determined whether the cancel button 653 has been pushed. If it is determined that the cancel button 653 has not been pushed (No in step S156), the printer search process returns to in step 143, and a standby state maintains until the user pushes the search area selection button 652 or the cancel button 653.

If it is determined that the search area selection button 652 has been pushed (Yes in step S144), in step S145, an inquiry about specifications and statuses is transmitted to all of printers constituting the group selected in the list box 651. Each of the printers having receiving the inquiry transmits its specifications to the inquirer. Therefore, the PC 100 acquires the specifications and status of each of the printers. The specification information includes at least information on the search parameters settable in the main screen 61 (paper handling sizes, whether color printing is supported, whether duplex printing is supported, and handling resolutions). The specification information further includes information on an handling page description language (PDL). The status information includes information on whether printing is possible and which error has occurred if printing is impossible.

Next, in step S146, the search condition set in the main screen 61 is acquired, and the selected group is searched for printers satisfying the search condition. If a plurality of printers is searched for, in step S147, the searched printers are sorted according to the display method selected in the main screen 61. Next, in step S148, the searched printers are displayed in the list box 611 of the main screen 61 in the order arranged in step S147. After the list display, in an initial state, all of printers capable of printing are in the selected state.

Next, in step S149, inquiring of the user about whether to register the search results acquired by step S146 is executed. If an instruction to register the search results is issued (Yes in step S149), in step S150, the search results are registered as a transmission destination printer group in the PC 100. That is, the search results are stored in the HDD 54 of the PC 100. The name of the transmission destination printer group may be set by the user or may be automatically assigned by the PC 100, during registration. After the search area group is registered or if an instruction not to register the search results is issued (No in step S149), in step S151, the display of the search area selection screen 65 finishes, thereby ending the printer search process.

Meanwhile, if it is determined that the cancel button 653 has been pushed (Yes in step S156), in step S151, the display of the search area selection screen 65 finishes without executing printer search, thereby ending the printer search process.

[Transmission-Destination Selection Process]

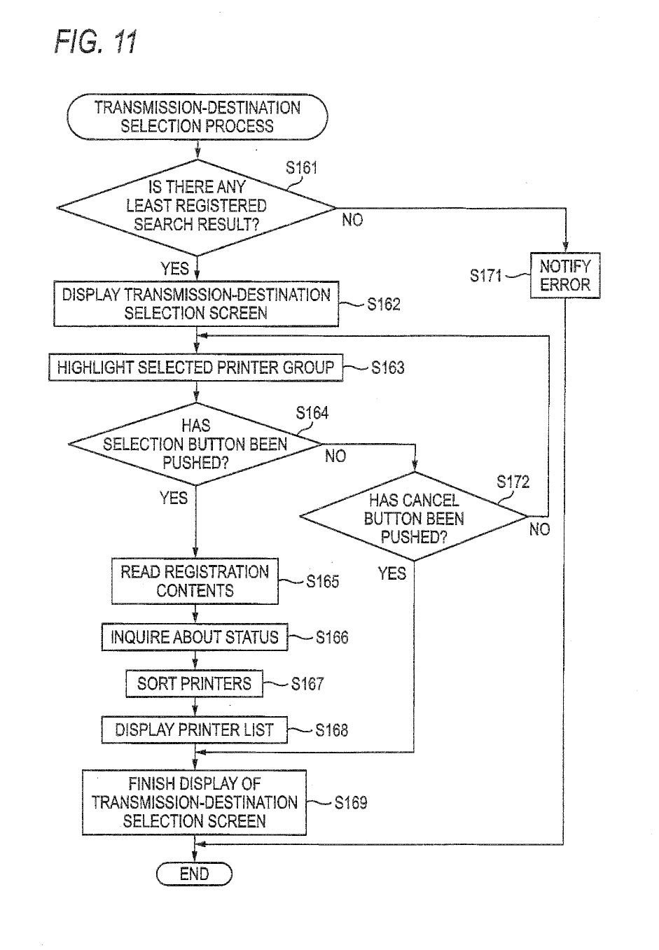

Subsequently, a transmission-destination selection process will be described with reference to a flow chart of FIG. 11. The transmission-destination selection process is executed by the CPU 51 if the transmission-destination selection button 616 of the main screen 61 is pushed.

In the transmission-destination selection process, first, in step S161, it is determined whether there is at least one search result registered in the PC 100. If it is determined that there is no registered search results (No in step S161), in step S171, an error message representing that there is no registered search results is notified, thereby ending the transmission-destination selection process.

Meanwhile, if it is determined that there is at least one registered search result (Yes in step S161), in step S162, the transmission-destination selection screen 66 (see FIG. 8) is displayed. At this time, a list of search results (transmission destination printer groups) registered in the PC 100 is displayed in the list box 661. After this list display, in an initial state, a transmission destination printer group displayed on the top of the list box 661 is in the selected state. Next, in step S163, if the user selects a transmission destination printer group by manipulation, the selected transmission destination printer group is highlighted.

Next, in step S164, it is determined whether the selection button 662 has been pushed. If it is determined that the selection button 662 has not been pushed (No in step S164), in step S172, it is determined whether the cancel button 663 has been pushed. If the cancel button 663 has not been pushed (No in step S172), the transmission-destination selection process returns to step S163, and a standby state maintains until the user pushes the selection button 662 or the cancel button 663.

If it is determined that the selection button 662 has been pushed (Yes in step S164), in step S165, the contents of the search result selected in the list box 661 are read, and in step 166, an inquiry about a status is transmitted to all of printers recorded in the search result. Since the specifications are recorded in the search result, inquiring about the specifications is unnecessary; however, inquiring about the specifications may be re-executed. In a case where inquiring about the specifications is re-executed, the specifications can be updated. Next, in step S167, the printers recorded in the search result are sorted according to the display method selected in the main screen 61. Then, in step S168, the printers recorded in the search result are displayed in the list box 611 of the main screen 61 in the order arranged in step S167. After this list display, in an initial state, all of printers capable of printing are in the selected state. Next, in step S169, the display of the transmission-destination selection screen 66 finishes, thereby ending the transmission-destination selection process.

Meanwhile, if it is determined that the cancel button 663 has been pushed (Yes in step S172), in step S169, the display of the transmission-destination selection screen 66 without reading the search results, thereby ending the transmission-destination selection process.

[Job Transmission Process]

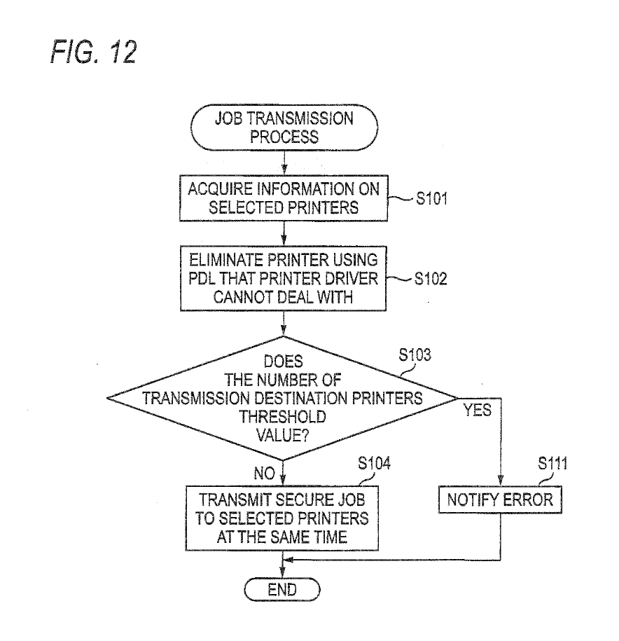

Subsequently, a job transmission process (an example of the transmission unit and the prohibition unit) will be described with reference to a flow chart of FIG. 12. The job transmission process is executed by the CPU 51 if the transmission button 612 of the main screen 61 is pushed.

In the job transmission process, first, in step S101, information on printers (transmission destination printers) selected in the list box 611 of the main screen 61 is acquired. The PC 100 has stored the address (for example, IP address), status, specifications, and the like of each of the printers displayed in the list box 611. In step S101, information on transmission destination printers of the printer group displayed in the list box 611 is acquired.

Next, in step S102, if there is any printer using a PDL, which the printer driver 110 cannot deal with, in the transmission destination printers, the corresponding printer is eliminated from the transmission destination printers. Whether the printer driver 110 can deal with a PDL of each printer can be determined by the specification information (see step S145) acquired from the corresponding printer.

Next, in step S103, it is determined whether the number of transmission destination printers exceeds a threshold value. If it is determined that the number of transmission destination printers does not exceed the threshold value (No in step S103), in step S104, the secure jobs are transmitted to all of the transmission destination printers. That is, print data having a PDL form are generated, and the print data are transmitted to the selected printers at the same time. After step S104, the job transmission process ends.

Meanwhile, if it is determined that the number of transmission destination printers exceeds the threshold value (Yes in step S103), in step S111, an error message representing that the number of transmission destination printers exceeds a defined value is notified. Then, the job transmission process ends. That is, inputting of the print jobs to a large number of printers is not desirable in terms of the load on the system and the secrecy of the data. For this reason, the number of printers for registering the print jobs therein is limited. In this case, the user narrows down the printers selected in the list box 611 or changes the printer search condition, and then performs work such as re-searching. This work makes the number of transmission destination printers smaller than the threshold value, so as to enable transmission of the secure job.

As described above, in order to determine which printers of the plurality of printers as registration destinations of the print jobs, the PC 100 of the printing system 500 of the present embodiment receives search condition for printers for registering the print jobs therein from the user through the main screen 61. Then, if the user pushes the transmission-destination-printer search button 615, the PC 100 narrows down printers satisfying the search condition, and displays the printers satisfying the search condition in the list box 611. Next, if the user pushes the transmission button 612, the PC 100 can collectively determine printers selected in the list box 611 as the transmission destinations of the print jobs. Therefore, the PC 100 of the present embodiment does not need cumbersome manipulation for selecting printers having desired specifications from a large amount of printers constituting the printing system 500, and need a little effort for selection of the registration destinations of the print jobs.

The present embodiment is merely an example, and does not limit the present invention. Therefore, the present invention can be improved and modified in various forms without departing from the scope. For example, the printer may be any device, such as a combined device or a copy machine, having a print function. Also, the information processing apparatus is not limited to a PC, but may be a portable information terminal or a workstation.

The embodiment is described by employing a printing system which registers print jobs in a plurality of printers; however the registered print jobs are not limited to secure jobs. That is, the present invention is applicable to any system in which print jobs based on the same print target are registered in a plurality of printers, and each printer starts printing in response to a print instruction of the print job, and the print jobs may not require authentication to start printing.

In the embodiment, the print jobs based on the same print target are registered to the selected printers. However, the print jobs are not necessarily required to be the same. That is, the registered print jobs may be different according to printer languages.

In the embodiment, during the secure-job transmission, the number of transmission destination printers is limited (step S103). However, the process of limiting the number of transmission destination printers may be executed immediately before the secure-job transmission. For example, the process of limiting the number of transmission destination printers may be executed immediately after the printer search of step S146 or immediately before the search result registration of step S150.

In the embodiment, the search area is determined in advance on an occasion of printer search. However, it is not necessarily required to set a search area. That is, in a case where a printer search subject is fixed, it is unnecessary to set a search area. If it is possible to set a search area, it is possible to narrow down a search subject and expect a reduction in load of a search process. Further, it is possible to narrow down the search subject by search parameters unrelated to specifications of printers.

In the embodiment, if the number of transmission destination printers excesses the threshold value (Yes in step S103), the job transmission process is canceled to give the user a chance to narrow down transmission destination printers. As a method of reducing the number of transmission destination printers, for example, the PC 100 may forcibly select printers to be eliminated, from the transmission destination printers. In this case, for example, printers having lower frequencies of use may be preferentially eliminated. The threshold value may be fixed or variable.

In the embodiment, although a printer is incapable of printing, the printer is displayed in the list box 611 of the main screen 61. However, any printers incapable of printing may not be displayed. In this case, a smaller number of printers are displayed in the list box 611 so as to facilitate the grasping of printers capable of printing. Meanwhile, if even printers incapable of printing are displayed, it is possible to accurately display printers satisfying the search condition and the user can recognize that defects has occurred in the printers.

In the embodiment, after the printer search, the searched printers in the list box 611 can be individually eliminated from the registration destinations by user's manipulation. However, the searched printers in the list box 611 may not be individually changed. That is, all of the searched printers or all of printers, capable of printing, of the searched printers may be automatically set as the registration destinations.

In the embodiment, the search result is registered in step S150 such that the registered search result can be used for the transmission-destination selection process. However, reusable information is not limited to the search result. For example, a search condition including search area information may be registered. That is, the search area information and the search condition may be stored in the HDD 54 of the PC 100. In this case, in order to use the registered search condition, the search condition may be read in step S165, inquiring of printers constituting a search area about specifications and statuses may be executed on the basis of the read search area information, and then printers satisfying the read search condition may be searched for. After the printer search, the processes of step S167 and the subsequent steps may be executed.

In the embodiment, the print-job transmission is executed immediately after the registration destination printers of the print jobs are determined. However, the print jobs may be transmitted during printing. In this case, for example, immediately after the registration destination printers of the print jobs are determined, only print requests of the print jobs may be transmitted to the printers. In this case, the print job remains in the PC 100. Then, any one of the printers having received the print requests may output a print-job transmission request to the PC 100 in response to a print instruction of the user, so as to acquire print data. In this configuration, the print jobs are not stored in a plurality of printers such that the confidentiality of the print jobs is improved. Meanwhile, if printers store print jobs as in the embodiment, after the user inputs a print instruction, it is possible to start printing earlier.

What is claimed is:

1. A printing system comprising:
a plurality of printers; and
an information processing apparatus including:
a designation unit configured to receive, from user's input, search condition for searching the printers in which print jobs are to be registered;
a search unit configured to search for the printers satisfying the search condition received by the designation unit;
a determination unit configured to determine the printers from the printers searched by the search unit; and
a registering unit configured to register print jobs based on a same print target in the printers determined by the determination unit,
wherein the printer in which the print job is registered starts printing in response to a print instruction.

2. The printing system according to claim 1 further comprising a transmission unit configured to transmit the print jobs to all of the printers determined by the determination unit.

3. The printing system according to claim 1 further comprising a prohibition unit configured to prohibit the number of printers in which the print jobs are to be registered from exceeding a threshold value when the registration destination printers of the print jobs are determined.

4. The printing system according to claim 1 further comprising a selection unit configured to allow the user to select the printer to eliminate the selected printer from the printers in which the print jobs are to be registered,
wherein the determination unit determines the printers except the printer selected by the selection unit.

5. The printing system according to claim 1 further comprising a search-result storage unit configured to store printer search results of the search unit,
wherein if the search result is stored in the search-result storage unit, the determination unit reads the search results and determines the printers based on the search result.

6. The printing system according to claim 1 further comprising a search condition storage unit configured to store the search condition received by the designation unit,
wherein if the search condition is stored in the search condition storage unit, the determination unit reads the search condition, and the search unit searches for the printers based on the search condition.

7. The printing system according to claim 1 further comprising a setting unit configured to set a printer search area which is a search subject of the search unit,
wherein the search unit searches the search area set by the setting unit for printers.

8. The printing system according to claim 1, wherein the search unit searches for printers having the same data form as that of the print jobs to be registered.

9. The printing system according to claim 1, wherein
a plurality of conditions are settable in the designation unit, and
the designation unit is able to designate at least one of a logical product of the conditions and a logical sum of the conditions.

10. An information processing apparatus for controlling a plurality of printers, comprising:
a designation unit configured to receive, from user's input, search condition for searching the printers in which the print jobs are to be registered; and
a search unit configured to search for the printers satisfying the search condition received by the designation unit; and
a determination unit configured to determine the printers from the printers searched by the search unit; and
a registering unit configured to register print jobs based on a same print target in the printers determined by the determination unit.

11. A printing system comprising:
a plurality of printers; and
an information processing apparatus including:
an interface coupled to the plurality of printers;
a processor; and
a memory storing instructions which, when executed by the processor, performs the steps of;
receiving a search condition for searching the printers in which print jobs are to be registered;
searching for the printers satisfying the search condition in the plurality of printers from the printers coupled to the interface; and
registering print jobs in printers satisfying the search condition searched in the searching step,
wherein the printer in which the print job is registered starts printing in response to a print instruction.

12. The printing system according to claim 11, wherein the memory further stores an instruction which, when executed by the processor, performs transmitting the print jobs to all of the printers satisfying the search condition.

13. The printing system according to claim 11, wherein the memory further stores an instruction which, when executed by the processor, performs stopping the registering step if a number of the printers in which the print job is registered reaches to a predetermined number.

14. The printing system according to claim 11 further comprising search-result storage unit configured to store printer search results of the searching step,
wherein if the search result is stored in the search-result storage unit, the processor uses the search results for searching for the printers satisfying the search condition.

15. The printing system according to claim 11 further comprising a search condition storage unit configured to store the search condition in the receiving step,
wherein if the search condition is stored in the search condition storage unit, the processor uses the search condition for searching for the printers satisfying the search condition.
